(19) United States
(12) Patent Application Publication
(10) Pub. No.: US 2019/0320638 A1
(43) Pub. Date: Oct. 24, 2019

(54) Method and apparatus to kill bed bugs without the use of toxic chemicals

(71) Applicant: Ronald L. Ketner, Prescott, AZ (US)

(72) Inventor: Ronald L. Ketner, Prescott, AZ (US)

(21) Appl. No.: 14/756,024

(22) Filed: Jul. 22, 2015

(51) Int. Cl. A01M 1/20; G01K 11/12

(52) U.S. Cl. CPC A01M 1/2094; G01K 11/12

(57) ABSTRACT

A method to eliminate bed bugs. The method includes the steps of providing a substrate; apply a temperature sensitive chemical indicator to the substrate; and, calibrating a clothes dryer to determine the time required to kill bed bugs by placing dry bedding in the dryer.

This invention pertains to bed bugs.

More particularly, it pertains to a method and apparatus to eliminate bed bugs.

Those of skill in the art have for many year concentrated on methodologies for eliminating bed bugs.

Therefore, it would be desirable to provide an improved method and apparatus to eliminate or minimize the presence of bed bugs.

Therefore, it is a principal object of the instant invention to provide an improved method and system to eliminate or minimize the presence of bed bugs.

This and other, further and more specific objects and advantages of the invention will be apparent from the following detailed description thereof, taken in conjunction with the drawings, in which:

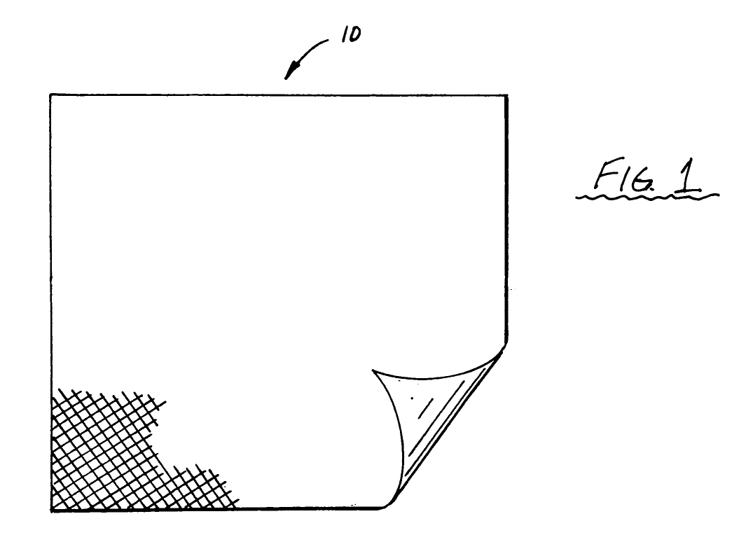

FIG. 1 is a perspective view illustrating a dryer sheet constructed in accordance with the invention;

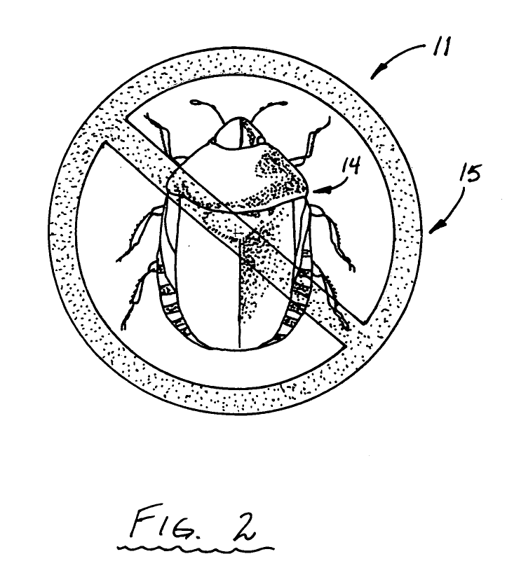

FIG. 2 is a top view illustrating a design which can be formed on a dryer sheet constructed in accordance with the invention; and,

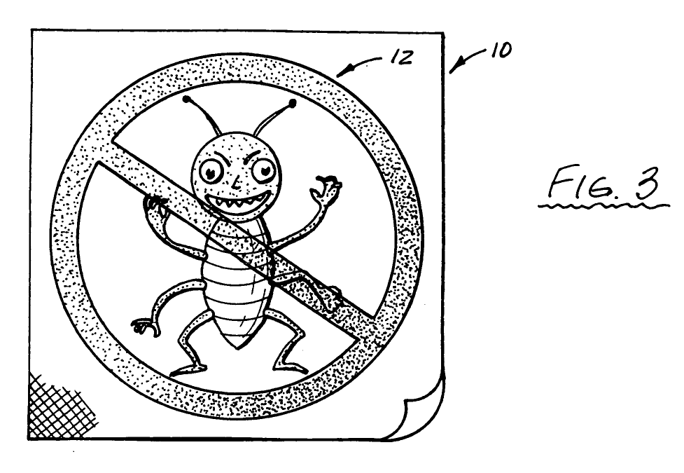

FIG. 3 is a top view illustrating another design which can be formed on a dryer sheet constructed in accordance with the invention.

Briefly, in accordance with the invention, I provide an improved method for eliminating bed bugs. The method comprises the steps of providing a thin, pliable substrate comprised of interconnected fibers; applying to the substrate a temperature sensitive chemical indicator, the indicator changing color when the chemical indicator is exposed to a temperature of at least one hundred and fifteen degrees F.; providing a clothes dryer; placing the substrate in the clothes dryer; operating the clothes dryer for a selected period of time; after the selected period of time expires, removing the substrate from the dryer; examining the substrate to determine if the chemical indicator changed color indicating that the temperature in the dryer reached at least one hundred and fifteen degrees F.; and, in the event the chemical indicator changes color, obtaining bedding, placing the bedding in the dryer, and operating the dryer for a selected period of time to kill bed bugs in the bedding.

In accordance with another embodiment of the invention, provided is a method for eliminating bed bugs. The method comprises the steps of providing a thin, pliable substrate comprised of interconnected fibers; applying to the substrate a temperature sensitive chemical indicator, the indicator changing color when the chemical indicator is exposed to a temperature of at least one hundred and fifteen degrees F.; providing a clothes dryer; and, calibrating the dryer. The dryer is calibrated by placing the substrate in the clothes dryer; operating the clothes dryer for a selected period of time; after the selected period of time expires, removing the substrate from said dryer; and, examining the substrate to determine if the chemical indicator changed color indicating that the temperature in the dryer reached at least one hundred and fifteen degrees F. If the chemical indicator changed color, the method comprises the additional steps of obtaining dry bedding; placing the bedding in the dryer; and, operating the dryer for a selected period of time to kill bed bugs in the bedding.

Turning now to the drawings, which depict the presently preferred embodiments of the invention for the purpose of illustrating the practice thereof and not by way of limitation of the scope of the invention, and in which like reference characters refer to corresponding elements throughout the several views, FIG. 1 illustrates a dryer sheet 10 constructed in accordance with the invention. Dryer sheet 10 has had applied a chemical indicator which is not visible at room temperature, but which becomes visible at a temperature of 115 degrees or more. When visible, the chemical indicator depicts a design or object or alphanumeric characters or other desired symbols.

FIG. 2 illustrates one possible design which appears after dryer sheet 10 is exposed to a temperature of 115 degrees F. and the chemical indicator becomes visible to the naked eye of a user. FIG. 3 illustrates another such design.

The substrate comprising sheet 10 can comprise paper or any other material produced using woven or non-woven fibers or any other desired material. It can be absorbent or non-absorbent. It can comprise a sponge. Although a pliable sheet is presently preferred in the practice of the invention, the substrate need not consist of a sheet. The shape and dimension and size and physical properties of the substrate can vary as desired. For example, in one embodiment of the invention, a clothes dryer is outfitted with a temperature sensor and an externally mounted LCD readout which permits a user to monitor the temperature inside a dryer while standing next to the dryer while the dryer is running.

In a further embodiment of the invention, a temperature sensor is mounted inside a dryer on one of the fins which extend inwardly from the inside of the hollow rotating dryer cylinder in which clothes are tumbled while the dryer operates. When clothes are removed from the dryer, a user can—to determine if the desired temperature (or temperature—time) was reached—view the temperature sensor that is mounted on a dryer fin. The temperature sensor could change color when a desired temperature is reached, or when a desired temperature is reached for a desired period of time.

Examples of fibers which can be utilized in the construction of a pliable sheet 10 are fibers of materials such as jute, hemp, silk, wool, cotton, linen, sisal, ramie, rayon, cellulose esters, vinyl polymers, polyamide, polyesters, and polyethylene terephthalate.

While the composition of materials utilized to produce a substrate in accordance with the invention can, as noted, vary as desired, in the presently preferred embodiments of the invention dangerous chemicals often used in conventional dryer sheets are preferably avoided.

Conventional dryer sheets and fabric softeners can waterproof clothes to make them feel softer. Chemicals found in such products can include:
Ethyl acetate: A narcotic on the EPA's Hazardous Waste list.
Chloroform: Neurotoxic, anesthetic and carcinogenic.
Formaldehyde: An embalming fluid.
Linalool: A narcotic that causes central nervous system disorders.
Benzyl acetate: Linked to pancreatic cancer.
Limonene: A known carcinogen.
Benzyl alcohol: Upper respiratory tract irritant.
Ethanol: On EPA's hazardous waste list and can cause central nervous system disorders.
Camphor: Causes central nervous system disorders.
A-Terpineol: Can cause respiratory problems, including fatal edema, and central nervous system damage.
Pentane: A chemical known to be harmful if inhaled.
   To hide chemical smell, companies may load dryer sheets full of chemical fragrances, which also are potentially carcinogenic.

In addition, the chemicals in dryer sheets often are incorporated so the chemicals stay on clothing for extended periods of time and slowly release chemical components during a day. This produces extended exposure to toxic chemicals.

Chemical fragrances and other toxins in dryer sheets enter the body both through inhalation or by absorption through the skin.

Symptoms produced by prolonged exposure to the chemicals in fabric softeners and dryer sheets can include mucous membrane and respiratory tract irritation, liver damage, skin irritation, difficulty concentrating and remembering, headaches, dizziness, central nervous system disorders, nausea, vomiting, cancer, blood pressure reduction, fatigue, and difficulty breathing.

Alternatives such as PurEcoSheet™ reusable, chemical-free dryer sheets are available. PurEcoSheet sheets are made from 99% polyester and 1% nylon.

Fabric softeners typically function to prevent static cling. One easy way to avoid using fabric softeners is to use clothing and bedding articles made from natural fibers. In the practice of the invention, dryer sheets are preferred which do not incorporate “additives” including fabric softeners, fragrances, water proofing chemical compositions including in particular and without limitation the dangerous or toxic chemical compositions specifically listed above (chloroform, formaldehyde, etc.). One important reason such additives are avoided is that they can interfere with incorporating thermochromic and other chemical compositions set forth below and with the functioning of such compositions.

A temperature-specific chemical indicator is affected only by heat. A multi-parameter chemical indicator integrator responds to a combination of conditions like temperature, time, and the presence of steam.

In a temperature specific chemical indicator, the chemical quickly changes color when exposed to a certain temperature. Such chemical indicators can, by way of example and not limitation, comprise paper strips or tabs or printed markings on the outside of a sterilization pouch. Strips on autoclave tape, indicator areas on paper strips, and imprinted pouch markings can contain a thermochromic ink that is sensitive to heat.

A multi-parameter chemical indicator integrator can, by way of example, be in the form of a paper strip, liquid in a vial, or a pellet in a packet. Some integrators utilize thermochromic ink while others use other systems.

When a substance changes color due to a change in temperature, the substance is thermochromatic. Two common approaches in producing a thermochromatic composition are to use liquid crystals and leuco dyes.

One advantage of liquid crystals is that they can be engineered to accurately change color at specific temperatures. The color range of liquid crystals is, however, limited. Some liquid crystals display different colors at different temperatures. Such a change depends on the selective reflection of light wavelengths by the crystallic structure of the liquid crystals as they change from the low temperature crystallic phase, through the anisotropic chiral or twisted nematic phase, to the high-temperature isotropic liquid phase. Only the nematic mesophase has thermochromic properties, which limits the effective temperature range of the material. Examples of such material are cholesteryl nonanoate and cynaobiphenyls. Liquid crystals that are used in dyes and inks often are microencasulated in the form of a suspension. Liquid crystals can be difficult to work with, can require specialized printing equipment, and can generate more expense than alternative technologies. The life span of liquid crystals can be negatively impacted by high temperatures, ultraviolet radiation, and some chemicals and/or solvents.

Thermochromic dyes are based on mixtures of leuco dyes and other chemicals. Leuco dyes allow a wider range of colors to be used. Their response to temperature is more difficult to get to accurately change at a selected temperature. Such dyes normally are a sealed, microencapsulated form and normally are not directly applied to a material. One such microencapsulated form utilizes crystal violet lactone, a weak acid, and a dissociable salt dissolved in dodecanol. When the solvent is solid, the dye is in a lactone leuco form. When the solvent melts, the salt dissociates, the pH inside the microcapsule lowers, the dye becomes protonated, its lactone ring opens, and its absorption spectrum shifts significantly, producing a deep violet color. In this case the apparent thermochromism is in fact halochromism. Halchromic materials change color when pH changes occur.

Dyes, inks, or any other desired temperature/time/moisture sensitive chemical compositions can be formed on or in a dryer sheet or any other object utilized in the practice of the invention.

In one preferred embodiment of the invention, the dye, ink, or other material applied to a pliable sheet (or other substrate) is invisible at room temperature, but becomes visible to the naked eye after the dye or ink has been exposed to a temperature equal at least to one hundred and fifteen degrees F.; has been exposed to a temperature equal at least to one hundred and fifteen degrees for a selected length of time; or, has been exposed to a temperature equal to at least to one hundred and fifteen degrees for a selected length of time and to a selected quantity of moisture. When a chemical indicator which is invisible at room temperature becomes visible at an elevated temperature, such is considered to be a change in color in the context of the invention described herein.

In another preferred embodiment of the invention, the dye, ink, or other material applied to a pliable sheet (or other substrate) has a first visible color at room temperature, but visibly changes color after the dye or ink has been exposed to a temperature equal at least to one hundred and fifteen degrees F.; has been exposed to a temperature equal at least to one hundred and fifteen degrees F. for a selected length of time; or, has been exposed to a temperature equal to at least one hundred and fifteen degrees for a selected length of time and to a selected quantity of moisture.

### Dryer Calibration

The current barometer in terms of killing bedbugs is to subject them to a temperature of 115 degree F. for at least seven minutes. A typical clothes dryer produces “incoming” air temperatures in the range of 130 to 175 degrees F. When, however, a dryer is initially started incoming air has not reached such an elevated temperature. Further, when clothes are added to a clothes dryer, the initial temperature of the clothes slows the rate at which the clothes dryer achieves a temperature in the range of 130 to 175 degrees F. And, the quantity of clothes added to dryer affects the rate of temperature ascension, as does whether the clothes have just been washed and are damp.

A dryer sheet or other temperature sensitive device constructed in accordance with the invention can end up being “tumbled” at the center of a dryer cylinder “inside” a ball of clothing or bedding, and, may only reach a temperature of less than 115 degrees, or, only reach a temperature of 115 degrees for a time period of less than seven minutes. Consequently, one of the problems identified during development of the invention was how to ascertain with reasonable certainly that a temperature of 115 degrees or more has been reached for more than seven minutes, especially since the quantity and water content of clothing placed in a dryer can vary widely.

Dryers often have two or more “heat” settings such as “high”, “medium”, “low”. In the following examples, it is assumed the dryer setting is on “high”, although the examples can be repeated using the “medium” or “low” setting.

### EXAMPLE 1

In accordance with one embodiment of the invention, it is decided that the clothing or bedding placed in a clothes dryer to kill bed bugs will be is dry.

Several temperature dryer sheets are provided each of which includes a chemical indicator that will change temperature once it is exposed to a temperature in excess of 115 degrees F.

Calibration Trial #1: A clothes dryer is provided, and the dryer is turned on while empty, or with only a small quantity of dry clothing (for example, a shirt or towel) in the dryer. After the dryer is on for three to five minutes, the dryer is stopped and one of the dryer sheets of the invention is inserted in the dryer and the dryer is operated three to five more minutes (or for any other selected period of time), after which the sheet is removed and examined. It ordinarily would be expected that the thermochromic material on or in the dryer sheet would have changed color, simply because it is well known that clothes dryer normally heat to operating temperature in the range of 130 to 175 degrees F. relatively quickly. If the dryer sheet has not changed color, the dryer sheet is immediately re-inserted and checked after several more minutes (or any other selected period of time), after which the dryer sheet is removed and inspected. The dryer sheet should have changed color. If it has not, the sheet is immediately reinserted one last time and the dryer is operated for several more minutes. If after this additional “drying” time, the sheet still has not changed color, it is assumed the dryer is not reaching a temperature of 115 degrees F. The total elapsed time during which the dryer is operated before the thermochromic material in or on the sheet changes color is noted, and seven minutes is added to the time to produce the Preliminary Bed Bug Elimination Time. Seven minutes represents the minimum amount of time at 115 degrees F. which is necessary to kill bed bugs. If, for example, the total elapsed time is ten minutes, then the Preliminary Bed Bug Elimination Time would be ten minutes (the dryer operating time which passed before the thermochromic material in the sheet changed color) plus seven minutes or seventeen minutes.

Calibration Trial #2: It is assumed that in Calibration Trial #1 the total elapsed time is ten minutes, although it is believed that in a normal dryer the actual time required would be significantly less. A typical load of dry bedding is provided. Such a load could, by way of example, comprise a pair of bed sheets (the “bottom” and “top” sheets) and a pair of pillow cases. The load is put into the dryer with a time/temperature dryer sheet located at the center of the dryer cylinder and surrounded by the bedding. The dryer is operated for the ten minute period determined in Calibration Trial #1. The dryer is stopped and the dryer sheet of the invention is removed from the dryer. The dryer sheet should be located within the bedding and not on the periphery of the bedding. The thermochromic dye or other temperature sensitive material on the dryer sheet should have changed color to indicate that a temperature of 115 degrees F. has been reached. This generally reconfirms the results of Calibration Trial #1. If the thermochromic material on or in the dryer sheet has not changed color, the sheet is reinserted in the bedding and the dryer operated for an additional period of time, typically just a few minutes. The dryer sheet is then removed again and viewed to determine if the thermochromic material has changed color. Based on the results of Calibration Trial #1, the thermochromic material should have changed color. If not, then Calibration Trial #1 should be repeated to insure the dryer is operating properly. Based on the results of Calibration Trial #1, it is highly unlikely that the thermochromic material in or on the dryer sheet will not have changed color after ten minutes, especially since the bedding material is dry. Once it is determined that the thermochromic material on the dryer sheet has changed color, the dryer is immediately restarted for an additional period of time of at least seven minutes to insure the demise of any bed bugs present in the bedding.

### EXAMPLE 2

Time/temperature dryer sheets are utilized which each have a time/temperature chemical indicator which changes color after the sheets are exposed to a temperature of at least 115 degrees F. for a selected period of time, namely, a period of time that is at least seven minutes.

Calibration Trial #1: When one of such time/temperature dryer sheets is placed in a dryer with a minimal amount of dry clothing (i.e., a shirt or towel), the dryer is initially operated for about 10 minutes, after which the dryer sheet is removed to determine if the time/temperature chemical indicator on or in the dryer sheet has changed color (due to exposure to a 115 degree temperature for at least seven minutes). In this Example 2, the initial ten minute period of time includes several minutes for the dry to warm up to normal operating temperature. If the time/temperature chemical indicator in or on the dryer sheet has not changed color, it is returned to the dryer for an additional five minute period, and then for an another additional five minute period if it still does not change color. If the time/temperature chemical indicator on or in the dryer sheet does not change color after the last five minute period it is presumed the dryer simply does not achieve a 115 degree F. temperature for an appropriate period of time. If the chemical indicator on or in the sheet does, however, change color during Calibration Trial #1, the total elapsed time (i.e., the total time required for the dryer to be operated before the time/temperature chemical indicator on or in the dryer sheet changes color) is noted. For example, if after 10 minutes of dryer operation the time/temperature chemical indicator on the dryer sheet changes color, then that time is noted as the total elapsed time. Seven minutes is added to the total elapsed time to produce the Preliminary Bed Bug Elimination Time.

Calibration Trial #2. It is assumed that in Calibration Trial #1 the total elapsed time is ten minutes, and that, consequently, the Preliminary Bed Bug Elimination Time is seventeen minutes. A regular load of dry bedding (two sheets and two pillow cases) is placed in the dryer with a new time/temperature dryer sheet. The time/temperature dryer sheet is placed at the center of the bedding. The dryer is operated for ten minutes, after which the dryer is stopped and the dryer sheet is removed. The location of the dryer sheet is noted and preferably is in the interior of the bedding. If the time/temperature chemical indicator on or in the time/temperature dryer sheet has changed color, and the dryer sheet was removed from within the bedding on the interior of the dryer, then the results of Calibration Trial #1 are generally confirmed and the total elapsed time is sufficient. If on the other hand, the time/temperature chemical indicator on or in the dryer sheet has not changed color, then the dryer sheet is immediately placed back in the dryer (with the bedding), and the dryer is operated for an additional selected period of time (one minute, two minutes, four minutes, etc) after which the time/temperature dryer sheet is removed and inspected to see if the time/temperature chemical indicator has changed color. If after this re-insertion the dryer sheet still has not changed color, then the time/temperature dryer sheet is once again immediately reinserted for an additional selected period of time (one minute, two minutes, etc.). If after this additional period of time the dryer sheet still has not experienced a color changer, that strongly suggests that the results of Calibration Trial #1 are not being reproduced and that the dryer is not operation efficiently, especially since the “load” of bedding in this example is relatively small. Calibration Trial #1 is therefore repeated. Normally, however, when the dryer sheet is removed after the total elapsed time of ten minutes has passed, the time/temperature chemical indicator will have changed color and the dryer will immediately be operated for at least an additional seven minutes to insure the demise of any bed bugs which are present.

The foregoing examples can, of course, be repeated by using dryer loads of varying size and by varying the time periods which are used before removing a dryer sheet from a clothes dryer to determine whether the entire dryer sheet (or other object), or only a portion of the dryer sheet, has changed color. In every case, however, the purpose of the calibration is to be able to reasonably determine whether and when the dryer reaches a temperature of at least one hundred and fifteen degrees and/or to reasonably determine within a few minutes the length of time that a dryer must be operated to kill bed bugs. Once it is established that a dryer reaches a temperature of one hundred and fifteen degrees F. and how long it takes the dryer to achieve that temperature, then adding an additional running time of at least seven minutes to obtain a total running time is normally sufficient to insure that bed bugs are killed by running the dryer for the total running time, i.e. by running the dryer for the Preliminary Bed Bug Elimination Time.

When the objective of placing dry clothes in a dryer is to kill bed bugs, smaller dryer loads comparable to those set forth in the above examples are preferred because the dryer more quickly arrives at a temperature which kills bed bugs.

Similarly, the foregoing examples can be repeated using dryer loads comprised of damp clothes which are transferred from a washing machine to the dryer. In such cases, the time required to heat the entire load to at least one hundred and fifteen degrees is, of course, significantly longer, and clothes or bedding which “ball up” at the center of the dryer may not reach a temperature of one hundred and fifteen degrees until well after clothes on the periphery (and adjacent the inner wall of the drum in the dryer) have reached a temperature of 115 degrees F. Although the invention can be utilized when damp clothes are placed in a clothes dryer, the logistics and calibration sequences are more complicated and more difficult to accurately carry out; consequently, the presently preferred embodiments of the invention focus on incorporating dry clothing or bedding article in a dryer. In that context, the two conventional ways in which a clothes dryer is used are (1) drying damp clothing produced by washing cloths in a washing machine, and (2) “fluffing” shirts or other dry articles by placing then in a clothes dryer for a short period of time, typically only a few minutes. As can be appreciated, neither of these conventional uses of a dryer are appropriate or preferred in the practice of the invention.

FIG. 1 illustrates a pliable filament dryer sheet 10 constructed in accordance with the invention.

FIG. 2 illustrates a diagram which is formed on sheet 10 or other object utilized in the invention, which is invisible at room temperature, and which becomes visible at a temperature of one hundred and fifteen degrees F. Alternatively, the drawing of a bed bug 14 in FIG. 2 can be visible on sheet 10 at room temperature while the cross hash circle design 15 only becomes visible at a temperature of one hundred and fifteen degrees F.

As would be appreciated by those of skill in the art, the diagram or design such as, without limitation, those shown in FIG. 2 or FIG. 3 can be visible at room temperature but change, in whole or in part, color at a temperature of 115 degrees F. or more. In one embodiment of the invention, a design which is visible at room temperature on a dryer sheet changes color by disappearing and not being visible after the design reaches a selected elevated temperature. Portions of a design formed on a dryer sheet in accordance with the invention, can, as desired, become visible or change color at equivalent or different selected elevated temperatures. Further, the temperature at which a chemical indicator changes temperature can vary as desired. Having the chemical indicator change color at 120 degrees F. or 130 degrees F., etc. may be desirable to insure that bed bugs are killed when bedding or clothing is heated in a clothes dryer.

Some individuals are squeamish at the sight of an insect. Such cases may be addressed by forming on a dryer sheet 10 a more fanciful, cartoonish, or other preferred design of a bed “bug” and other symbol or object. An example of such a design 12 is illustrated on a dryer sheet 10 in FIG. 3.

Having described my invention in such terms as to enable those of skill in the art to understand and use it, and having described the presently preferred embodiments and best mode thereof, I claim:

1. A method for eliminating bed bugs comprising the steps of
(a) providing a thin, pliable substrate comprised of interconnected fibers;
(b) applying to said substrate a temperature sensitive chemical indicator, said indicator changing color when said chemical indicator is exposed to a temperature of at least one hundred and fifteen degrees F.;
(c) providing a clothes dryer;
(d) calibrating said dryer by
(i) placing said substrate in said clothes dryer,
(ii) operating said clothes dryer for a selected period of time;
(iii) after said selected period of time expires, removing said substrate from said dryer;
(iv) examining said substrate to determine if said chemical indicator changed color indicating that the temperature in said dryer reached at least one hundred and fifteen degrees F.; and,
(h) in the event in step (g) said chemical indicator changes color,
(i) obtaining dry bedding,
(ii) placing said bedding in said dryer, and
(iii) operating said dryer for a selected period of time to kill bed bugs in said bedding.
